(19) United States
(12) Patent Application Publication
(10) Pub. No.: US 2007/0136184 A1
(43) Pub. Date: Jun. 14, 2007

(54) Sharing credit information between credit-providing companies and debt-collection companies

(76) Inventors: Robert J. Goodman, Birmingham, MI (US); Jeffrey G. Poeszat, Commerce Twp, MI (US); Gary S. Portney, San Francisco, CA (US)

Correspondence Address: LAW OFFICES OF MICHAEL DRYJA, 704 228TH AVENUE NE, PMB 694, SAMMAMISH, WA, 98074, US

(21) Appl. No.: 11/299,215

(22) Filed: Dec. 9, 2005

(51) Int. Cl. G06Q 40/00

(52) U.S. Cl. 705/38

(57) ABSTRACT

Credit information is shared between credit-providing companies and debt-collection companies. A computer-implemented method includes receiving over a network first data from credit-providing companies. The first data represents credit information regarding debtors. This first data is stored within a centralized database. The method also includes receiving over the network second data representing queries from debt-collection companies and which are to be proceeded against the first data stored within the centralized database. Each query relates to a debtor that has defaulted on debt thereof. Each query is processed against the first data stored within the centralized database, yielding third data representing the credit information of the debtor to which the query in question relates. The method further includes sending the third data over the network to the debt-collection company from which the query was received.

### FIELD OF THE INVENTION

The present invention relates generally to credit information regarding debtors, and more particularly to sharing such information between credit-providing companies, or creditors, and debt-collection companies, which attempt to secure repayment of debts by defaulting debtors.

### BACKGROUND OF THE INVENTION

Many individuals, as well as companies and other types of entities, incur different types of debts. For instance, such debts can include revolving credit, such as credit cards, among other types of revolving credit, as well as fixed-term debts, such as auto loans, home equity loans, home mortgages, and personal loans, among other types of fixed-term debts. A large majority of debtors pay off their debts as agreed to on a timely basis. However, a minority of debtors do not, and default on their debts.

A credit-providing company, such as a credit card company, a loan company, a mortgage company, or another type of company, at its first recourse typically tries to work out a debt-repayment plan with a debtor who has defaulted on a debt. However, where this approach fails, credit-providing companies usually turn over the debts on which debtors have defaulted to debt-collection companies. Generally, debt-collection companies pay credit-providing companies a certain percentage of an outstanding debt. The debt-collection companies themselves make money by collecting a larger portion of the outstanding debt, above and beyond what they had paid to the credit-providing companies.

To successfully collect a debt on which a debtor has defaulted, a debt-collection company needs to have access to all the credit information, or “media,” regarding the debt. For example, with respect to a credit card debt, such credit information can include the original credit card contract in accordance with which credit was extended to a debtor, as well as the monthly credit card statements for the credit card in question. This information is needed so that the debt-collection company can successfully build a case concerning the debtor, to at best convince the debtor to repay his or her debt, and at worst to successfully sue the debtor in a legal court for repayment.

However, such credit information, or “media,” regarding the debtors of defaulted debtors is often come by in a very haphazard manner. Credit-providing companies may only retain certain such information in paper form. Even if credit information is stored in electronic form, it is often difficult to provide to debt-collection companies in a timely and cost-effective manner. As a result, it can be more difficult for debt-collection companies to secure repayment of defaulted debt, which in turn means that they are willing to pay a lesser percentage of the outstanding debt to the credit-providing company.

For these and other reasons, therefore, there is a need for the present invention.

### SUMMARY OF THE INVENTION

The present invention relates to sharing credit information between credit-providing companies and debt-collection companies. A computer-implemented method of an embodiment of the invention includes receiving over a network first data from credit-providing companies. The first data represents credit information regarding debtors. This first data is stored within a centralized database. The method also includes receiving over the network second data representing queries from debt-collection companies and which are to be proceeded against the first data stored within the centralized database. Each query relates to a debtor that has defaulted on debt thereof. Each query is processed against the first data stored within the centralized database, yielding third data representing the credit information of the debtor to which the query in question relates. The method further includes sending the third data over the network to the debt-collection company from which the query was received.

A computerized system of an embodiment of the invention includes a network component, a database, a first software component, and a second software component. The network component is to communicatively couple to the computerized system to a network. The database is to store first data representing credit information regarding a number of debtors. The first software component is to receive the first data over the network from a number of credit-providing companies. The second software component is to receive second data over the network from a number of debt-collection companies and which represents a number of queries. Each query relates to a debtor that has defaulted on debt thereof. The second software component is also to process each query against the first data stored within the database to yield third data representing the credit information of the debtor to which the query in question relates. The second software component is further to send this third data over the network to the debt-collection company from which the query in question was received.

An article of manufacture of an embodiment of the invention includes a tangible computer-readable medium, and means in the medium. The tangible computer-readable medium may be a recordable data storage medium, or another type of tangible computer-readable medium. The means is for receiving first data over a network from a number of credit-providing companies and which represents credit information regarding a number of debtors. The means is also for storing the first data within a centralized database, as well as for receiving over the network second data representing a number of queries relating to the debtors, from a number of debt-collection companies. The means is further for processing the queries against the first data stored within the centralized database to yield third data representing the credit information of the debtors to which the queries relate. In addition, the means is for sending the third data over the network to the debt-collection companies.

Embodiments of the invention provide for advantages over the prior art. In particular, debt-collection companies are able to easily acquire all the credit information, or “media,” regarding debtors in relation to whom they have obtained defaulted debt from credit-providing companies. After a debtor has defaulted on a debt, or even before the debtor has defaulted, a credit-providing company that extended credit that is the subject of the debt transmits credit information regarding the debt, which is stored in a centralized database. A debt-collection company is able to query the centralized database in order to obtain the credit information regarding the debt.

Because the debt-collection company has the credit information it needs to secure repayment of the debt, it is more likely to secure such debt repayment from the debtor. Furthermore, because the debt-collection company is more likely to secure debt repayment, it is more likely to pay a larger percentage of the debt in purchasing the debt from the credit-providing company, which means that the credit-providing company is out less money than in the prior art. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram depicting a representative environment in which credit information is sent from credit-providing companies for storage on a centralized database, which is then queried by debt-collection companies, according to an embodiment of the invention.

FIG. 2 is a block diagram of a computerized system that can be employed in relation to the environment of FIG. 1, according to an embodiment of the invention.

FIG. 3 is a flowchart of a method, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

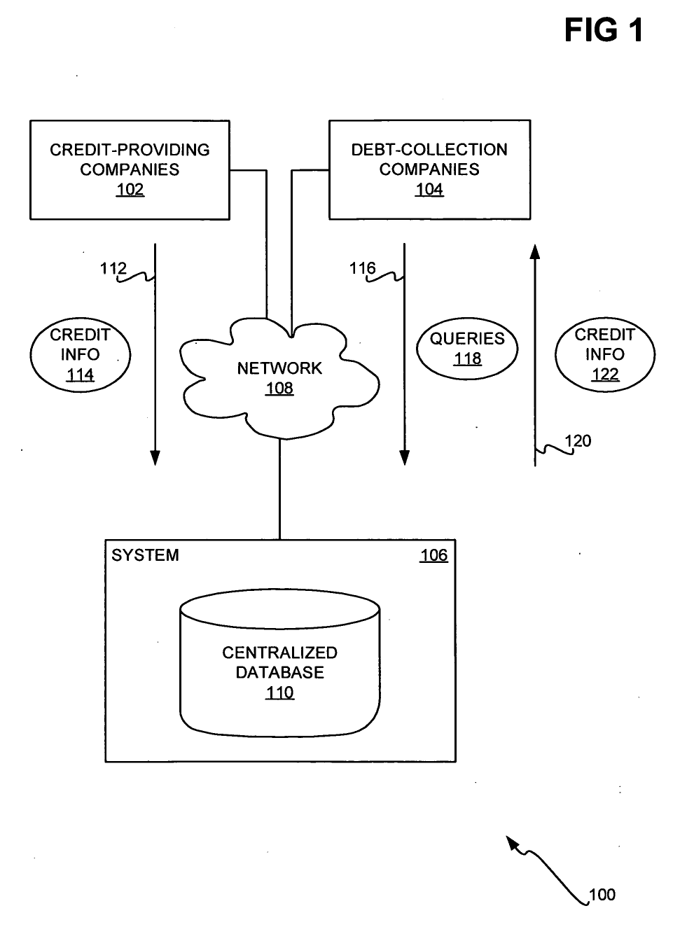

FIG. 1 shows a representative operating environment 100, according to an embodiment of the invention. The environment 100 includes a number of credit-providing companies 102, a number of debt-collection companies 104, and a computerized system 106. The companies 102 and 104 communicate with the computerized system 106 via a network 108. The network 108 can be one or more of: the Internet, an intranet, an extranet, a local-area network (LAN), and a wide-area network (WAN), among other types of networks.

As indicated by the arrow 112, the credit-providing companies 102 send first data representing credit information 114 regarding a number of debtors over the network 108, to the system 106. The system 106 stores the credit information 114 on a centralized database 110. In one embodiment, computerized systems of the credit-providing companies 102 without human interaction automatically communicate with the system 106 over the network 108 to provide this information 114. In another embodiment, employees or other users of the credit-providing companies 102 log onto the computerized system 106 over the network 108 to upload the credit information 114.

Furthermore, in one embodiment, the credit information 114 regarding a number of debtors is transmitted by the credit-providing companies 102 regardless of whether the debtors have defaulted on the debts associated with the credit information 114. For instance, soon after a new debt has been incurred by a debtor, the credit information 114 associated with the debt is sent to the system 106 for storage at the database 110 thereat. In another embodiment, however, the credit information 114 includes just the credit information regarding debtors that have defaulted on their debts. That is, once a debtor has defaulted on his or her debt, the credit information 114 associated with the debt is sent to the system 106 for storage at the database 110 thereat.

As indicated by the arrow 116, the debt-collection companies 104 send second data representing queries 118 relating to one or more of the debtors over the network 108 to the system 106. The system 106 processes each of the queries 118 against the first data representing the credit information 114 as stored at the centralized database 110. Processing the queries 118 yields third data representing the credit information 122 that particularly relates to the debtors of the queries 118. That is, the third data representing the credit information 122 is a subset of the first data representing the credit information 114. As indicated by the arrow 120, the system 106 sends the third data representing the credit information 122 back to the debt-collection companies 104 that generated the second data representing the queries 118.

For example, an employee or user of a debt-collection company may log onto the system 106 through the network 108. Once logged on, the employee or user sends a query (i.e., second data representing the query) to the system 106 to be processed against the centralized database 110. The query relates to a debtor for which the debt-collection company needs credit information. The system 106 in response processes the query against the database 110, to yield third data which represents the credit information 122, which is the portion of the credit information 114 stored at the database 110 that relates to the debtor of the query. The system 106 sends this third data back to the employee or user over the network 108.

Thus, the environment 100 allows a debt-collection company to easily obtain the credit information, or “media,” regarding a defaulting debtor. The debt-collection company simply submits a query over the network 108 to the system 106 to obtain this information, which has been previously stored at the centralized database 110. In response, the system 106 returns the requested information to the debt-collection company, which can then use this information to assist in securing repayment of the debt incurred by the defaulting debtor.

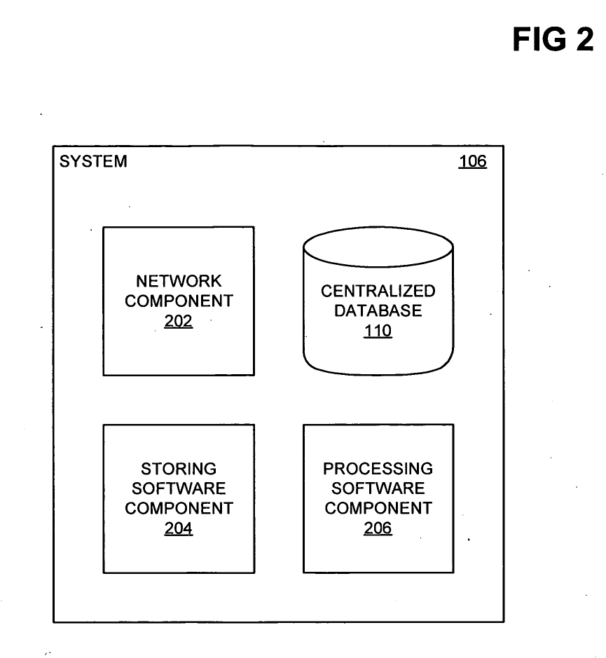

FIG. 2 shows the computerized system 106 in more detail, according to an embodiment of the invention. The system 106 is depicted as including the centralized database 110, a network component 202, a storing software component 204, and a processing software component 206. As can be appreciated by those of ordinary skill within the art, the system 106 can and typically does include other software and/or hardware components, in addition to and/or in lieu of those depicted in FIG. 2.

The network component 202 is a hardware component that allows the system 106 to be communicatively coupled to the network 108. The network component 202 may be a network adapter, such as an Ethernet adapter, for instance. Each of the software components 204 and 206 can in one embodiment be or include a web-based application, accessible over the network 108. A web-based application is generally and non-restrictively defined as an application in which all or part of it is downloaded by computing devices of the companies 102 and 104 from the system 106 each time it is run.

The storing software component 204 specifically receives the first data representing the credit information 114 over the network 108 from the credit-providing companies 102, via the network component 202, and stores the first data at the centralized database 110. The processing software component 206 specifically receives the second data representing the queries 118 over the network 108 from the debt-collection companies 104, via the network component 202. The processing software component 206 further processes the queries 118 against the first data stored within the database 110 to yield third data representing the credit information 122 relating to the debtors that are the subject of the queries 118. The processing software component 206 then returns the third data to the debt-collection companies over the network 108 via the network component 202.

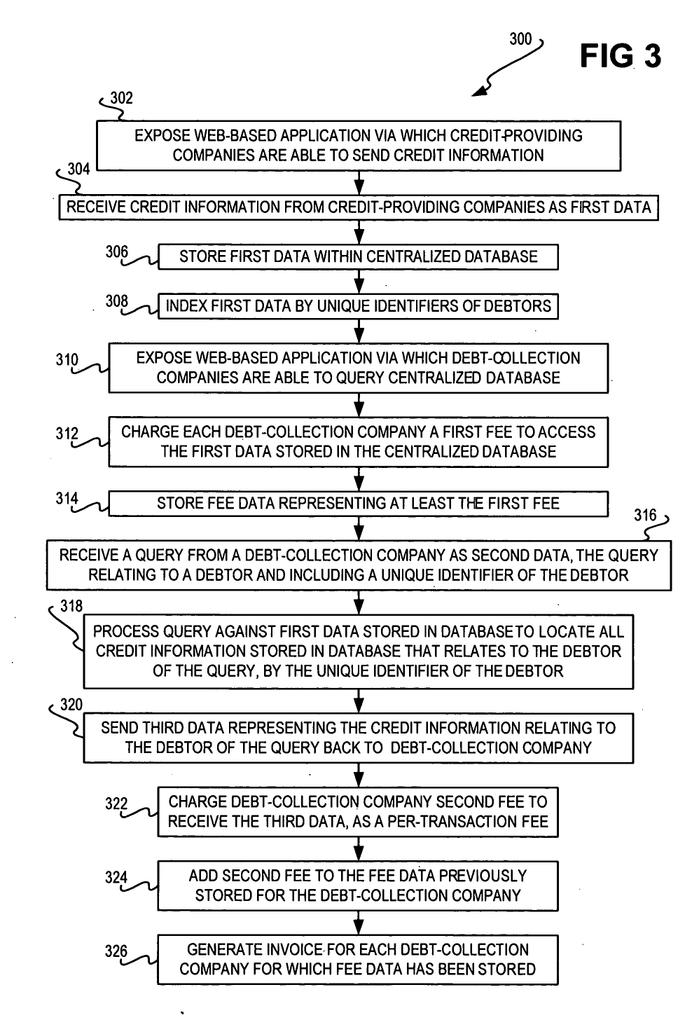

FIG. 3 shows a method 300 that can be performed by the computerized system 106 in relation to the environment 100, according to an embodiment of the invention. The method 300 may be implemented in software, hardware, or a combination of software and hardware. Not all parts of the method 300. are necessary to implement embodiments of the invention. As one example, the method 300 is described in relation to a particular embodiment in which to assess fees to the debt-collection companies, whereas other embodiments of the invention can assess fees to the debt-collection companies in other ways.

The system 106 exposes a web-based application, such as by or of the storing software component 204, via which the credit-providing companies 102 are able to send the credit information 104 to the system 106 (302). Thereafter, the system 106 receives the credit information 104, as first data, over the network 108 from the credit-providing companies 102 (304). This first data is stored within the centralized database 110 (306).

In one embodiment, each piece of credit information relates to a given debtor, who is identified by a unique identifier, such as a social security number. In this embodiment, then, the first data is indexed by the unique identifiers of the debtors (308). The credit information may include credit card statements, credit card contracts, and other types of credit information.

The system 106 also exposes a web-based application, such as by or of the processing software component 206, via which the debt-collection companies 104 are able to query the centralized database 110 (310). Each debt-collection company may be charged what is referred to as a first fee to access the first data stored in the centralized database 110 (312). This fee may be charged to each such company every given period of time, such as on an annual basis, a monthly basis, and so on, as a subscription fee. Fee data representing at least this first fee is stored for each debt-collection company by the system 106 (314).

The system 106 receives a query from a debt collection company, as second data (316). The query relates to a particular debtor, and in one embodiment includes the unique identifier of the debtor, such as the debtor's social security number. In response, the system 106 processes the query against the first data stored in the centralized database 110 (318). This results in the yielding of third data, which is the portion of the credit information 114 that relates to the particular debtor of the query. For instance, any and all pieces of credit information that have the same unique identifier of the debtor as the query does is part of the third data resulting from processing of the query against the centralized database 110.

This third data is then sent back to the debt-collection company (320). The debt-collection company that generated the query and that received the third data in response in one embodiment is charged a second fee (322), which may be considered a per-transaction fee. This second fee is added to the fee data previously stored for the debt-collection company (324). Thus, in one embodiment, a debt-collection company is charged two fees: a first fee which is a subscription fee, and a second fee which is a per-transaction fee. In other embodiments, fees may be assessed to the debt-collection companies in other ways. Periodically, invoices are then generated for the debt-collection companies for which fee data has been stored (326).

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. For example, the methods of different embodiments of the invention that have been described can be implemented as computer programs that are stored on computer-readable media of articles of manufacture. Such computer-readable media may be tangible computer-readable media, like recordable data storage media.

As another example, the terms “credit-providing company” and “credit information” are intended to be broadly construed. For instance, a credit-providing company may include a credit card-issuing company, a consumer- or business-loan-providing company, such as an auto-loan company, a medical institution like a hospital, an entity like a telecommunications or a utility company, as well as other types of credit-providing company. Medical institutions and entities like telecommunications and utility companies, for example, have open-account relationships with their debtors. They provide goods and/or services within a given period of time to a debtor, with the understanding as delineated in the credit-providing information that the debtor will pay back for the goods and/or services rendered. Thus, embodiments of the invention can be implemented in relation to any type of debt collection in which credit in any way has been extended to a debtor, which may be a person or a legal entity like a company. Therefore, it is manifestly intended that this invention be limited only by the claims and equivalents thereof.

We claim:

1. A computer-implemented method comprising:
receiving over a network first data from a plurality of credit-providing companies, the first data representing credit information regarding a plurality of debtors;
storing the first data within a centralized database;
receiving over the network second data representing a plurality of queries from a plurality of debt-collection companies to be processed against the first data stored within the centralized database, each query relating to one of the debtors that has defaulted on debt thereof;
for each query,
processing the query against the first data stored within the centralized database, to yield third data representing the credit information of the one of the debtors to which the query relates; and,
sending the third data over the network to the debt-collection company from which the query was received.

2. The method of claim 1, wherein the network comprises the Internet.

3. The method of claim 1, further comprising initially exposing a web-based application via which the credit-providing companies are able to send the first data over the network.

4. The method of claim 1, further comprising initially exposing a web-based application via which the debt-collection companies are able to send the second data over the network and that represent queries to be processed against the first data.

5. The method of claim 1, wherein the credit information regarding the debtors comprises at least: credit card statements of the debtors; and, credit card contracts of the debtors.

6. The method of claim 1, further comprising indexing the first data within the centralized database by a unique identifier associated with each debtor.

7. The method of claim 6, wherein the unique identifier associated with each debtor comprises the social security number of the debtor.

8. The method of claim 6, wherein each query comprises the unique identifier associated with a debtor to which the query relates, such that the query is processed against the first data stored within the centralized database by returning all the credit information having the unique identifier, as the third data.

9. The method of claim 1, further comprising, for each debt-collection company:
charging the debt-collection company a first fee to access the first data stored within the centralized database, the fee chargeable to the debt-collection company every predetermined period of time; and,
storing fee data representing at least the first fee.

10. The method of claim 9, further comprising, upon receipt over the network of the second data representing a query from a debt-collection company:
charging the debt-collection company a second fee to receive the third data in response to processing the query represented by the second data, on a per-transaction basis; and,
adding the second fee to the fee data previously stored.

11. The method of claim 9, further comprising generating an invoice for each debt-collection company for which fee data has been stored, where the fee data represents a fee greater than zero.

12. A computerized system comprising:
a network component to communicatively couple the computerized system to a network;
a database to store first data representing credit information regarding a plurality of debtors;
a first software component to receive the first data over the network from a plurality of credit-providing companies; and,
a second software component to receive second data over the network from a plurality of debt-collection companies and representing a plurality of queries, each query relating to one of the debtors that has defaulted on debt thereof,
the second software component also to process each query against the first data stored within the database to yield third data representing the credit information of one of the debtors to which the query relates, and to send the third data over the network to the debt-collection company from which the query was received.

13. The computerized system of claim 12, wherein the first software component and the second software component each comprises a web-based application.

14. The computerized system of claim 12, wherein the credit information regarding the debtors comprises at least: credit card statements of the debtors; and, credit card contracts of the debtors.

15. The computerized system of claim 12, wherein the first data is indexed within the database by a unique identifier associated with each debtor, such that each query comprises the unique identifier associated with a debtor to which the query relates, and such that the query is processed against the first data stored within the database by returning all the credit information having the unique identifier, as the third data.

16. An article of manufacture comprising:
a tangible computer-readable medium; and,
means for receiving first data over a network from a plurality of credit-providing companies and representing credit information regarding a plurality of debtors, for storing the first data within a centralized database, for receiving over the network second data representing a plurality of queries relating to the debtors from a plurality of debt-collection companies, for processing the queries against the first data stored within the centralized database to yield third data representing the credit information of the debtors to which the queries relate, and for sending the third data over the network to the debt-collection companies.

17. The article of manufacture of claim 16, wherein the credit information regarding the debtors comprises at least: credit card statements of the debtors; and, credit card contracts of the debtors.

18. The article of manufacture of claim 16, wherein the first data is indexed within the centralized database by a unique identifier associated with each debtor, such that each query comprises the unique identifier associated with a debtor to which the query relates, and such that the query is processed against the first data stored within the centralized database by returning all the credit information having the unique identifier, as the third data.

19. The article of manufacture of claim 16, further comprising means for storing fee data for each debt-collection company, the fee data representing a first fee charged to the debt-collection company every predetermined period of time, and a second fee charged to the debt-collection company for each query received from the debt-collection company and processed, on a per-transaction basis.
